(19) United States
(12) Patent Application Publication
(10) Pub. No.: US 2023/0237218 A1
(43) Pub. Date: Jul. 27, 2023

(54) ROTATING MACHINERY EVALUATION DEVICE, ROTATING MACHINERY EVALUATION SYSTEM, TUNING METHOD FOR ROTATING MACHINERY EVALUATION DEVICE, AND ROTATING MACHINERY EVALUATION METHOD

(71) Applicant: MITSUBISHI HEAVY INDUSTRIES, LTD., Tokyo (JP)

(72) Inventors: Hiroshi ITO, Tokyo (JP); Norikazu TEZUKA, Kanagawa (JP)

(21) Appl. No.: 18/126,543

(22) Filed: Mar. 27, 2023

Related U.S. Application Data
(63) Continuation of application No. PCT/JP2022/007113, filed on Feb. 22, 2022.

(30) Foreign Application Priority Data
Feb. 25, 2021 (JP) 2021-029114

(51) Int. Cl. G06F 30/20; G01M 99/00

(52) U.S. Cl. CPC G06F 30/20; G01M 99/005; G06F 2111/10

(57) ABSTRACT

Rotating machinery is evaluated by calculating a boundary condition based on a measured value of a parameter related to an operating state of the rotating machinery, and calculating an evaluation value corresponding to the calculated boundary condition based on the reduced order model, during operation of the rotating machinery. The reduced order model is created based on a prediction model including a heat transfer model and a structural model of the rotating machinery for predicting an evaluation value of the rotating machinery corresponding to the boundary condition.

### TECHNICAL FIELD

The present disclosure relates to a rotating machinery evaluation device, a rotating machinery evaluation system, a tuning method for a rotating machinery evaluation device, and a rotating machinery evaluation method.

The present application claims priority based on Japanese Patent Application No. 2021-029114 filed on Feb. 25, 2021, the entire content of which is incorporated herein by reference. The present application is a continuation application based on a PCT Patent Application No. PCT/JP2022/007113 whose priority is claimed on Japanese Patent Application No. 2021-029114. The content of the PCT Application is incorporated herein by reference.

### BACKGROUND ART

Rotating machinery such as a turbine that handles a hot fluid such as steam or gas generates thermal stress in its interior. Such thermal stress can cause damage to components of the rotating machinery and affect the service life. Therefore, thermal stress and damage are useful as evaluation values for evaluating the life of rotating machinery, and it is necessary to pay attention to them as monitoring items in the operation of rotating machinery.

As one method for obtaining such evaluation values, for example, in rotating machinery provided with a rotor (rotating member) that can be rotated by a hot fluid and a casing (stationary member) that rotatably supports the rotor, a measurement result of a temperature sensor installed in the casing is input as a surface temperature condition for a radial one-dimensional heat transfer/structural rotor model prepared in advance to obtain the temperature or thermal stress inside the rotor. As an alternative method, the finite element method (FEM) may be used to evaluate the temperature or stress of the rotor using operating data and various measurement data of rotating machinery as analysis conditions (see Patent Document 1).

### CITATION LIST

### Patent Literature

Patent Document 1: JP2002-277382A

### SUMMARY

### Problems to be Solved

In the method for calculating evaluation values using the heat transfer/structural rotor model, the evaluation values can only be calculated near the temperature sensor (i.e., at the same position in the axial direction as the temperature sensor) because the model is a one-dimensional model in the radial direction, and this method is less accurate than the method using the finite element method. Meanwhile, the method using the finite element method has better evaluation accuracy than the method using heat transfer/structural rotor model, but it needs a large computational load. Therefore, it is difficult to apply these methods to real-time monitoring of evaluation values in rotating machinery under operation.

At least one embodiment of the present embodiments is made in view of the above circumstances, and an object thereof is to provide a rotating machinery evaluation device, a rotating machinery evaluation system, a tuning method for a rotating machinery evaluation device, and a rotating machinery evaluation method whereby it is possible to monitor an evaluation value during operation of rotating machinery accurately in real time.

### Solution to the Problems

In order to solve the above problems, a rotating machinery evaluation device according to at least one embodiment of the present embodiments includes: a boundary condition calculation unit for calculating a boundary condition based on a measured value of a parameter related to an operating state of rotating machinery; a storage unit for storing a reduced order model created based on a prediction model constructed so as to include a heat transfer model and a structural model of the rotating machinery for predicting an evaluation value of the rotating machinery corresponding to the boundary condition; and an evaluation value calculation unit for calculating the evaluation value corresponding to the boundary condition calculated by the boundary condition calculation unit, based on the reduced order model, during operation of the rotating machinery.

In order to solve the above problems, a rotating machinery evaluation device tuning method according to at least one embodiment of the present embodiments includes: a step of calculating a boundary condition based on a measured value of a parameter related to an operating state of rotating machinery; and a step of calculating an evaluation value corresponding to the calculated boundary condition, based on a reduced order model, during operation of the rotating machinery. The reduced order model is created based on a prediction model constructed so as to include a heat transfer model and a structural model of the rotating machinery for predicting an evaluation value of the rotating machinery corresponding to the boundary condition.

In order to solve the above problems, a rotating machinery evaluation system includes: a client terminal device; and a rotating machinery evaluation device capable of communicating with the client terminal device. The client terminal device includes a request means for requesting evaluation of rotating machinery to the rotating machinery evaluation device. The rotating machinery evaluation device includes: a boundary condition calculation unit for calculating a boundary condition based on a measured value of a parameter related to an operating state of the rotating machinery in response to request from the request means; a storage unit for storing a reduced order model created based on a prediction model constructed so as to include a heat transfer model and a structural model of the rotating machinery for predicting an evaluation value of the rotating machinery corresponding to the boundary condition; and an evaluation value calculation unit for calculating the evaluation value corresponding to the boundary condition calculated by the boundary condition calculation unit, based on the reduced order model, during operation of the rotating machinery.

### Advantageous Effects

At least one embodiment of the present embodiments provides a rotating machinery evaluation device, a rotating machinery evaluation system, a tuning method for a rotating machinery evaluation device, and a rotating machinery evaluation method whereby it is possible to monitor an evaluation value during operation of rotating machinery accurately in real time.

### BRIEF DESCRIPTION OF DRAWINGS

FIG. 1 is a schematic diagram showing a cross-sectional structure of rotating machinery.

FIG. 2 is a schematic configuration diagram of the rotating machinery evaluation device according to an embodiment.

FIG. 3 is a flowchart of the rotating machinery evaluation method according to an embodiment.

FIG. 4A is an example of an evaluation result output from the result output unit in FIG. 2.

FIG. 4B is another example of an evaluation result output from the result output unit in FIG. 2.

FIG. 5 is a diagram showing an outline of a prediction model.

FIG. 6 is a diagram showing a calculation flow in the prediction model of FIG. 5.

FIG. 7A is a diagram for explaining a method of constructing a reduced order model from a prediction model.

FIG. 7B is a diagram for explaining a method of constructing a reduced order model from a prediction model.

FIG. 7C is a diagram for explaining a method of constructing a reduced order model from a prediction model.

FIG. 7D is a diagram for explaining a method of constructing a reduced order model from a prediction model.

FIG. 7E is a diagram for explaining a method of constructing a reduced order model from a prediction model.

FIG. 7F is a diagram for explaining a method of constructing a reduced order model from a prediction model.

FIG. 8 is a flowchart of the rotating machinery evaluation device tuning method according to an embodiment.

FIG. 9A is a schematic diagram showing elongation of a rotor calculated as a structural index in step S402 of FIG. 8.

FIG. 9B is a schematic diagram showing elongation of a rotor calculated as a structural index in step S402 of FIG. 8.

### DETAILED DESCRIPTION

Embodiments of the present disclosure will be described below with reference to the accompanying drawings. It is intended, however, that unless particularly identified, dimensions, materials, shapes, relative positions, and the like of components described in the embodiments shall be interpreted as illustrative only and not intended to limit the scope of the present disclosure.

For instance, an expression of relative or absolute arrangement such as “in a direction”, “along a direction”, “parallel”, “orthogonal”, “centered”, “concentric” and “coaxial” shall not be construed as indicating only the arrangement in a strict literal sense, but also includes a state where the arrangement is relatively displaced by a tolerance, or by an angle or a distance whereby it is possible to achieve the same function.

For instance, an expression of an equal state such as “same” “equal” and “uniform” shall not be construed as indicating only the state in which the feature is strictly equal, but also includes a state in which there is a tolerance or a difference that can still achieve the same function.

Further, for instance, an expression of a shape such as a rectangular shape or a cylindrical shape shall not be construed as only the geometrically strict shape, but also includes a shape with unevenness or chamfered corners within the range in which the same effect can be achieved.

On the other hand, an expression such as “comprise”, “include”, “have”, “contain” and “constitute” are not intended to be exclusive of other components.

First, rotating machinery to be evaluated by the rotating machinery evaluation device or the rotating machinery evaluation method according to some embodiments will be described. A turbine that can be driven by a hot fluid will be described below as an example of the rotating machinery, but the rotating machinery may be any other device with a member that is rotatable at least partially. Further, in the present embodiments, a steam turbine using steam as the hot fluid will be illustrated, but other hot fluids such as gas may be used.

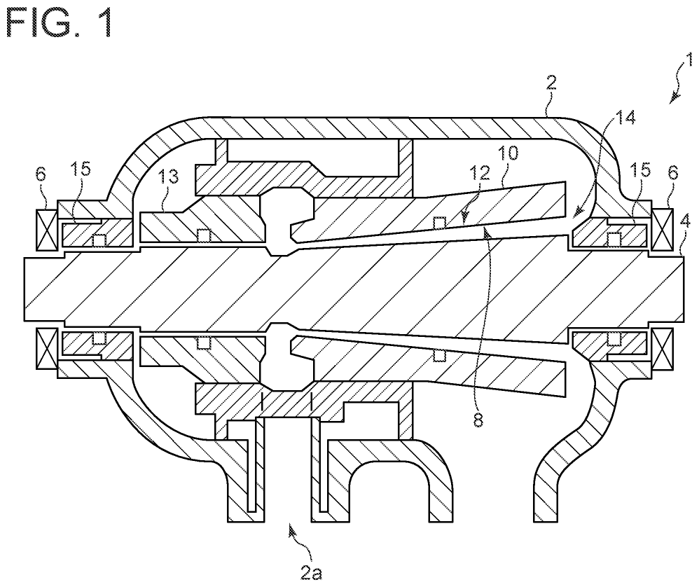

FIG. 1 is a schematic diagram showing a cross-sectional structure of rotating machinery 1. The rotating machinery 1 is a steam turbine using hot steam as a working fluid and includes a casing 2 and a rotor 4. The casing 2 surrounds a middle portion of the rotor 4. The rotor 4 is rotatably supported by radial bearings 6 on both sides of the casing 2.

The rotating machinery 1 is configured as an axial flow turbine, and a plurality of rotor blade rows 8 are fixed to the rotor 4 so as to be spaced apart from each other in the axial direction of the rotor 4. On the other hand, a plurality of stator vane rows 12 spaced apart from each other in the axial direction are fixed to the casing 2 via a blade ring 10, and a dummy ring 13 is fixed opposite to the blade ring 10 in the axial direction. The dummy ring 13 is provided with an inner gland 15 through which cooling gland steam can flow.

A cylindrical internal passage 14 is formed between the blade ring 10 and the rotor 4, and the rotor blade rows 8 and the stator vane rows 12 are arranged in the internal passage 14. The internal passage 14 communicates with a steam inlet portion 2a provided in the casing 2, and steam supplied from the steam inlet portion 2a is introduced to the internal passage 14. Each rotor blade row 8 is composed of a plurality of rotor blades (turbine rotor blades) arranged in the circumferential direction, and each rotor blade is fixed to the rotor 4. Each stator vane row 12 is composed of a plurality of stator vanes arranged in the circumferential direction of the rotor 4, and each stator vane is fixed to the blade ring 10. Each stator vane row 12 accelerates the flow of steam, and each rotor blade row 8 converts steam energy into rotational energy of the rotor 4. The rotor 4 is connected to, for example, a generator (not shown), and the rotor 4 drives the generator.

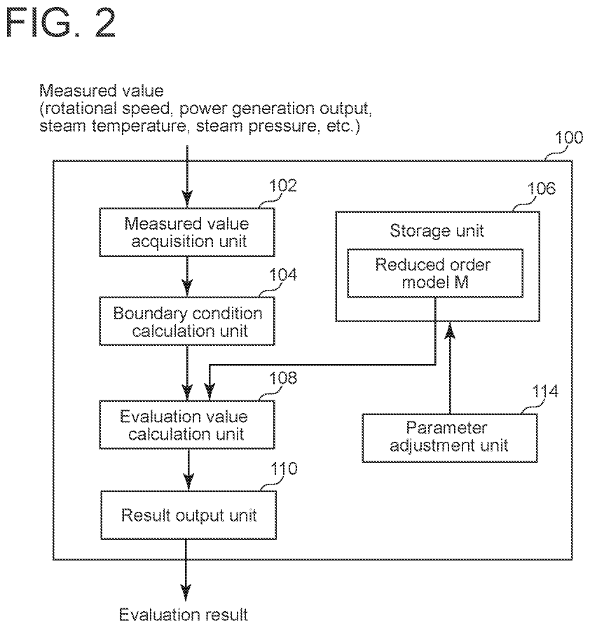

Next, a rotating machinery evaluation device 100 for evaluating the rotating machinery 1 will be described. FIG. 2 is a schematic configuration diagram of the rotating machinery evaluation device 100 according to an embodiment.

The rotating machinery evaluation device 100 includes, for example, a central processing unit (CPU), a random access memory (RAM), a read only memory (ROM), and a storage medium that is readable with a computer. Then, a series of processes for realizing various functions is stored in the storage medium or the like in the form of a program, as an example. The CPU reads the program out to the RAM or the like and executes processing/calculation of information, thereby realizing the various functions. The program may be installed in the ROM or another storage medium in advance, or may be stored in the computer-readable storage medium and provided, or may be distributed through wired or wireless communication means, for example. The computer-readable storage medium may be a magnetic disk, a magneto-optical disk, a CD-ROM, a DVD-ROM, or a semiconductor memory. Specifically, the rotating machinery evaluation device 100 includes a measured value acquisition unit 102, a boundary condition calculation unit 104, a storage unit 106, an evaluation value calculation unit 108, and a result output unit 110.

The measured value acquisition unit 102 is configured to acquire a measured value of a parameter related to the operating state of the rotating machinery 1. For example, the rotating machinery 1 is provided with a rotation speed sensor for measuring the rotation speed, a power generation output sensor for measuring the power output of the generator (not shown) connected to the rotor 4, a steam temperature sensor for measuring the steam temperature, and a steam pressure sensor for measuring the steam pressure. By receiving electric signals from these sensors, the measured value acquisition unit 102 can acquire a measured value of each parameter.

The boundary condition calculation unit 104 is configured to calculate a boundary condition set for a reduced order model M stored in the storage unit 106, based on the measured value acquired by the measured value acquisition unit 102. The reduced order model M is a model obtained by reducing the dimensionality (order reduction) while maintaining the essential behavior of the prediction model, and can significantly reduce analysis time and data volume. The reduced order model M is stored in advance in the storage unit 106, and the evaluation value calculation unit 108 calculates an evaluation value by applying the boundary condition calculated by the boundary condition calculation unit 104 to the reduced order model M read from the storage unit 106. The result output unit 110 is configured to output an evaluation result based on the evaluation value calculated by the evaluation value calculation unit 108.

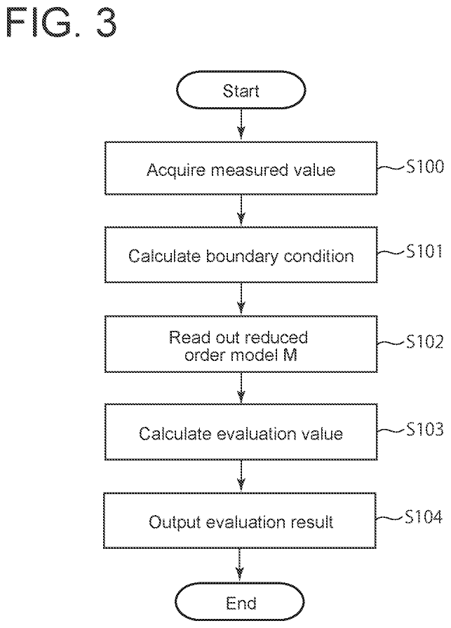

Next, the rotating machinery evaluation method implemented by the rotating machinery evaluation device 100 with the above configuration will be described. FIG. 3 is a flowchart of the rotating machinery evaluation method according to an embodiment.

During operation of the rotating machinery 1, the measured value acquisition unit 102 acquires a measured value of a parameter related to the operating state of the rotating machinery 1 (step S100). Acquisition of the measured value in step S100 is repeatedly performed during operation of the rotating machinery 1. By sequentially using the repeatedly acquired measured values to calculate evaluation values, which will be described later, the evaluation values of the rotating machinery 1 can be calculated in real time.

Then, the boundary condition calculation unit 104 calculates a boundary condition, based on the measured value acquired in step S100 (step S101). The boundary condition is obtained by a predetermined arithmetic expression corresponding to the reduced order model M used for calculating the evaluation value. In this embodiment, the rotation speed of the rotor 4, the power output of the generator (not shown), the steam temperature, the steam pressure, etc., are acquired as the measured values, and the boundary condition is calculated by inputting them into a predetermined arithmetic expression.

Then, the evaluation value calculation unit 108 accesses the storage unit 106 to read out the reduced order model M prepared in the storage unit 106 (step S102) and calculates the evaluation value by applying the boundary condition calculated in step S101 to the reduced order model M (step S103).

The reduced order model M used to calculate the evaluation value in step S103 is constructed by reducing the order of a prediction model that indicates the correlation between the boundary condition and the evaluation value. The prediction model used as a basis for the reduced order model typically includes a heat transfer model and a structural model of the rotating machinery 1. The prediction model can accurately calculate the evaluation value based on the boundary conditions by, for example, the finite element method, but the calculation load is enormous, so it is not suitable for calculating the evaluation value in real time as it is. Therefore, by reducing the order of the prediction model to construct the reduced order model M, it is possible to greatly reduce the computational load and calculate the evaluation value in real time.

A method for constructing the reduced order model M from the prediction model will be described in detail later.

Then, the result output unit 110 outputs an evaluation result based on the evaluation value calculated in step S103 (step S104). In this embodiment, at least one of temperature, stress, and damage in each part of the rotor 4 is calculated as the evaluation value, and the temporal change thereof is output from the result output unit 110.

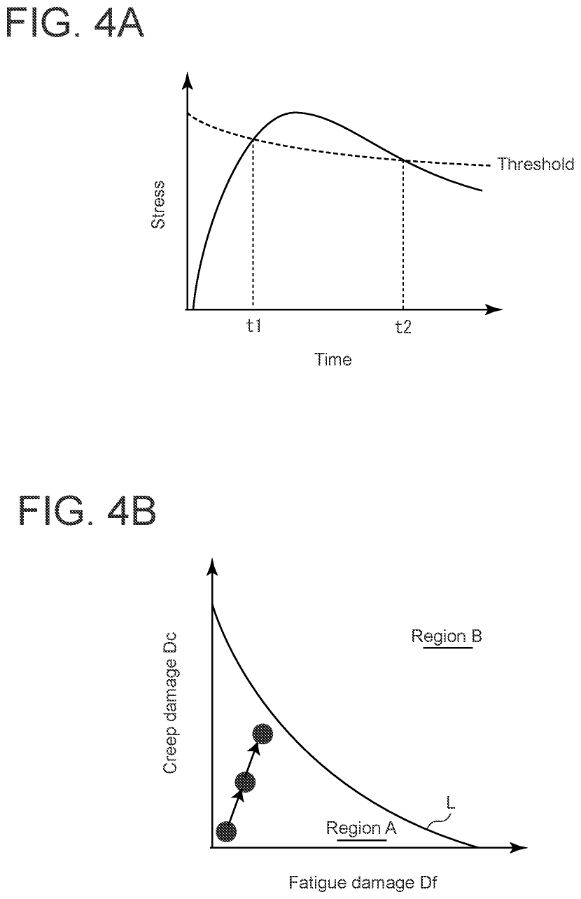

FIGS. 4A and 4B are examples of the evaluation result output from the result output unit 110 in FIG. 2. In FIG. 4A, the temporal change of stress in the rotor 4 calculated as the evaluation value is output, and the operator can monitor the stress in real time by referring to this. Further, in FIG. 4A, a threshold (proof stress) at which plastic deformation occurs is indicated by the dashed line. The figure indicates that plastic deformation may occur at time t1 to t2 due to the stress, which is the evaluation result, exceeding the threshold.

FIG. 4B shows creep damage Dc and fatigue damage Df obtained from stress of the rotor 4 calculated as the evaluation value, and the operating point of the rotating machinery 1 changing over time. In this example, a region A where the rotating machinery 1 can operate normally and a region B where an abnormality is likely to occur are separated by a boundary line L, and as the operating time of the rotating machinery 1 increases, the operating point approaches the region B from the region A.

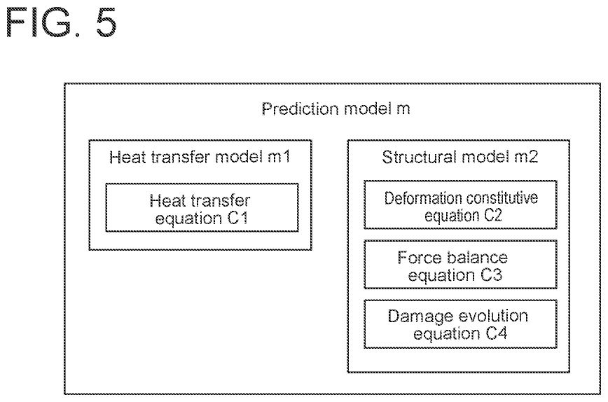

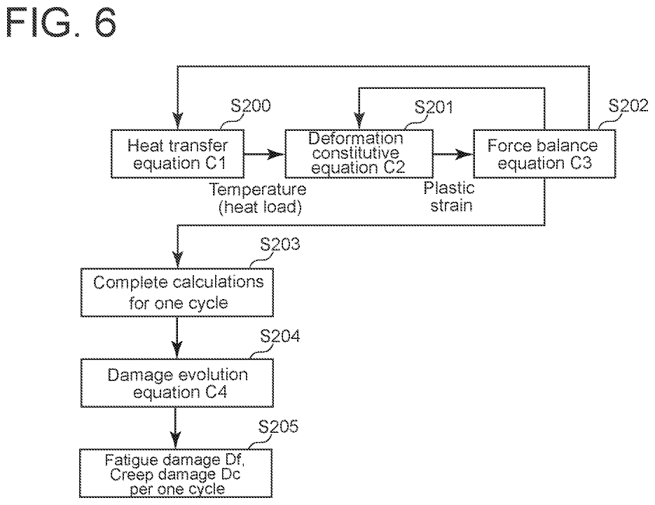

Such real-time evaluation of the rotating machinery 1 can be achieved by using the reduced order model M for calculating the evaluation value, as described above. Here, the method for constructing the reduced order model M from a base prediction model m will be described in detail. FIG. 5 is a diagram showing an outline of the prediction model m. FIG. 6 is a diagram showing a calculation flow in the prediction model m of FIG. 5.

As shown in FIG. 5, the prediction model m includes a heat transfer model m1 and a structural model m2. The prediction model m of this example has a heat transfer equation C1 as the heat transfer model m1, and a deformation constitutive equation C2, a force balance equation C3, and a damage evolution equation C4 as the structural model m2. In such a prediction model m, in damage FEM analysis, the heat transfer equation C1, the deformation constitutive equation C2, the force balance equation C3, and the damage evolution equation C4 are calculated to obtain temperature, stress, plastic strain, and time evolution of damage.

There are two ways to solve the deformation constitutive equation C2, the force balance equation C3, and the damage evolution equation C4, i.e., simultaneous and non-simultaneous methods. Since the construction method of the reduced order model is the same for both methods, the non-simultaneous method with a smaller computational load will be described here.

In the prediction model m, as shown in FIG. 6, the temperature (or heat load) is first calculated by the heat transfer equation C1 (step S200). Then, the temperature (or heat load) calculated by the heat transfer equation C1 and the stress (or displacement) calculated by the force balance equation C3 are input to the deformation constitutive equation C2 to calculate the plastic strain (step S201). In the force balance equation C3, the stress (or displacement) is calculated by inputting the plastic strain calculated by the deformation constitutive equation C2 (step S202). Steps S201 and S202 are repeated until the plastic strain and stress (or displacement) that simultaneously satisfy the deformation constitutive equation C2 and the force balance equation C3 are found.

Then, when the calculations of steps S200 to S202 for a certain time are completed, similar calculations are performed for the next time. Such calculations are repeated for one cycle from start to stop of the rotating machinery. When the calculations for one cycle are completed (step S203), the temperature (or heat load) calculated in step S200, the plastic strain calculated in step S201, and the stress (or displacement) calculated in step S202 for one cycle are prepared and input to the damage evolution equation C4. The damage evolution equation C4 calculates how the damage evolves, based on the prepared temperature (or heat load), stress (or displacement), and plastic strain for one step (step S204). In this embodiment, the fatigue damage Df and the creep damage Dc after one cycle are obtained as the calculation result of step S205 (step S205).

Next, the method for constructing the reduced order model M by reducing the order of such a prediction model m will be described.

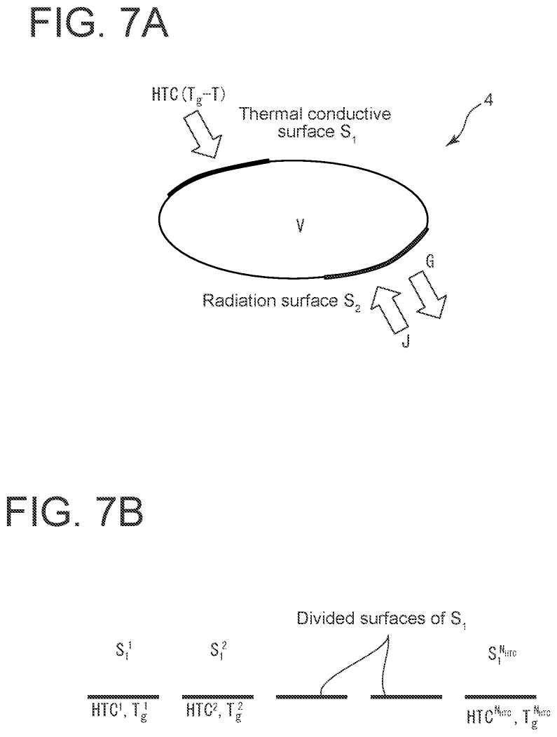

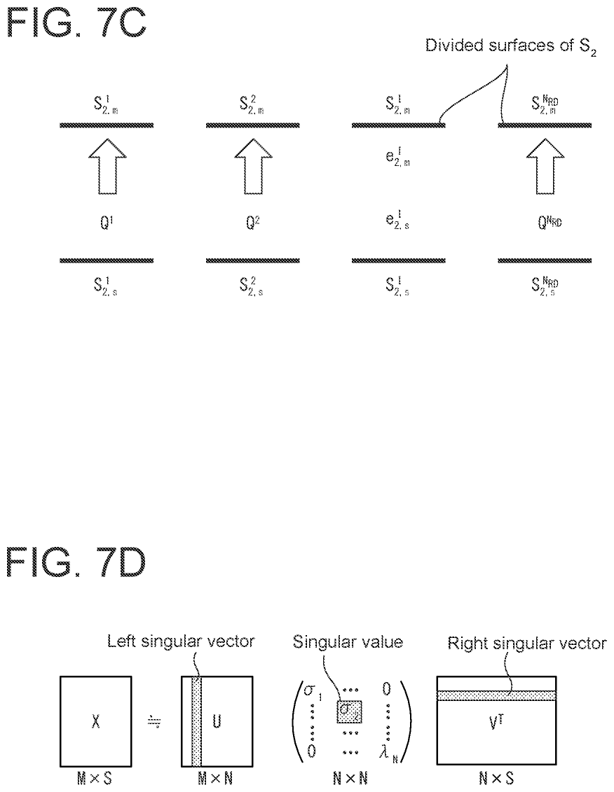

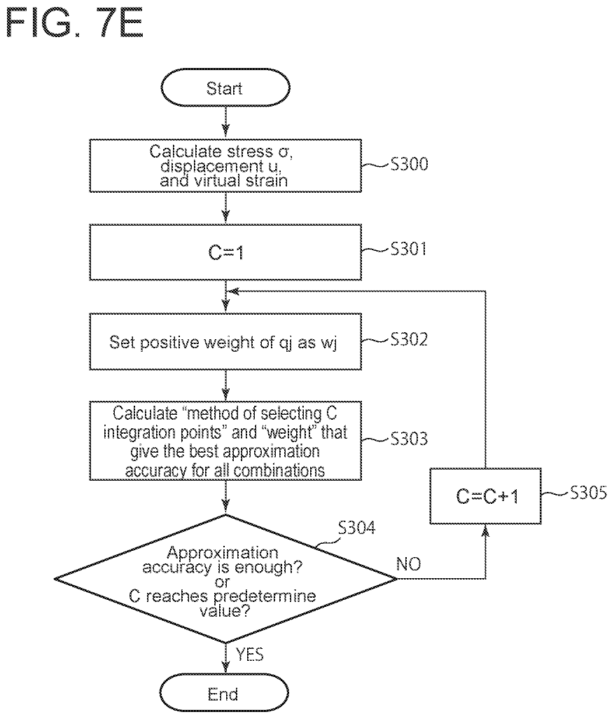

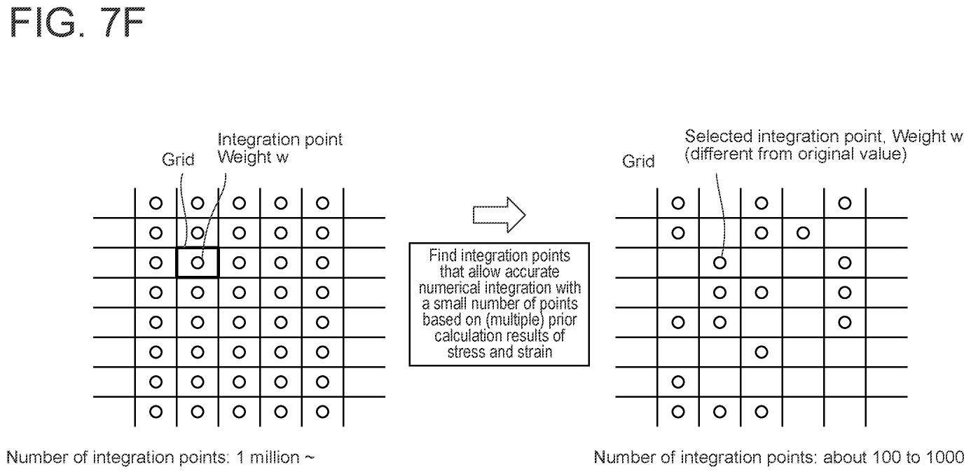

First, assuming that the rotating machinery 1 has a heat transfer surface S₁, a radiation surface S2, and a volume V, as shown in FIG. 7A, the heat transfer equation C1 included in the predictive model m is expressed by the following equation.

$${\int }_{V} ρ c δ T \frac{\partial T}{\partial t} d V + {\int }_{V} κ ( ∇ δ T ) \cdot ∇ TdV = {\int }_{S 1} HTC δ T ( {T}_{g} - T ) d S + {\int }_{S 2} δ T ( J - G ) dS \qquad ( 1 )$$

In equation (1), the first term on the left side is a heat capacity term, the second term on the left side is a heat conduction term, the first term on the right side is a heat transfer term, and the second term on the right side is a radiation term. In the equation, T is temperature, Tg is fluid temperature (temperature of steam or gas), p is density, c is specific heat, κ is thermal conductivity, HTC is heat transfer coefficient, J is incident heat flux, G is radiosity, δT is temperature variation, and S is area.

Here, the heat transfer term (the second term on the right side) of equation (1) can be expressed as follows, assuming that the heat transfer surface S₁ in FIG. 7A is composed of N_{HTC} divided surfaces S₁¹, S₁², . . . , S₁^{NHTC}, as shown in FIG. 7B.

∫ₛ_{₁}HTCδT(T_{g}−T)dS≈Σ_{I=1}^{N}^{_{HTC}}HTC^{l}[T_{g}^{l}∫_{S}_{₁}_{^{l}}δTdS−∫_{S}_{₁}_{^{l}}δT TdS] (2)

Further, the radiation term (the second term on the right side) of equation (1) can be expressed as follows, assuming that the radiation surface S2 in FIG. 7A is composed of N_{RD} pairs of divided surfaces (S¹_{2,s}, S¹_{2,m}), (S²_{2,s}, S²_{2,m}), (S^{NRD}_{2,s}, S^{NRD}_{2,m}), as shown in FIG. 7C.

$${\int }_{{S}_{2}} δ T ( J - G ) dS \approx {\sum }_{I = 1}^{{N}_{R D}} {Q}^{I} [ - \frac{1}{{A}_{1 , s}^{I}} {\int }_{{S}_{2 , s}^{I}} δ TdS + \frac{1}{{A}_{2 , s}^{I}} {\int }_{{S}_{2 , m}^{I}} δ TdS ] \qquad ( 3 )$$

Here, the radiant heat QI is expressed by the following equation using the areas A^{I}_{2,S}, A^{I}_{2,m} of the divided surfaces S^{I}_{2,s}, S^{I}_{2,m}.

$${Q}^{I} = σ ( \frac{1}{{e}_{{1}^{I}}} + \frac{1}{{e}_{{2}^{I}}} ) {A}_{1 , s}^{I} ( {( {T}_{1}^{I} )}^{4} - {( {T}_{2}^{I} )}^{4} ) \qquad ( 4 )$$

σ is Stefan Boltzmann constant, and e₁^{I}_{,S}, e₂^{I} are emissivity.

From the above equations (1) to (3), the following spatial discretization equation is obtained by the finite element method.

$$C \frac{d T}{d t} + K T = {\sum }_{I = 1}^{{N}_{H T C}} H T {C}^{I} ( {T}_{g}^{I} {E}^{I} - {M}^{I} T ) + {\sum }_{I = 1}^{{N}_{RD}} {Q}^{I} {R}^{I} {T}^{⋆ 4} \qquad ( 5 )$$

In the equation, T is N-dimensional nodal temperature vector, T*⁴ is N-dimensional vector obtained by raising each element of the nodal temperature vector to the fourth power, C, K, M^{I}, R^{I} are N×N matrices obtained by discretization, E^{I} is N-dimensional vector obtained by discretization.

In general, when N-dimensional truncated singular value decomposition (SVD) is applied to M×S matrix X, it is approximately decomposed as shown in FIG. 7D. Assuming that Tᵢ (i=1, . . . ) is a set of nodal temperature vectors obtained by solving equation (5), Uₕ is N×Nₕ matrix U when the Nₕ-dimensional truncated SVD is applied to X=[T₁, T₂, . . . ], and Wₕ is N×N_{q} matrix U when the N_{q}-dimensional truncated SVD is applied to X=[T*⁴₁, T*⁴₂, . . . ], POD Galerkin projections of the heat capacity term, the heat conduction term, and the heat transfer term in equation (5) are represented by the following expressions.

$$C \frac{\partial T}{\partial t} ⇒ ( {U}_{h} {}^{T} C {U}_{h} ) \frac{d {ϕ}_{h}}{dt} ( 6 - 1 ) \qquad ( 6 - 1 )$$

$$KT ⇒ ( {U}_{h} {}^{T} K {U}_{h} ) {ϕ}_{h} \qquad ( 6 - 2 )$$

$${T}_{g}^{I} {E}^{I} - {M}^{I} T ⇒ {T}_{g}^{I} {U}_{h} {}^{T} {E}^{I} - ( {U}_{h} {}^{T} {M}^{I} {U}_{h} ) {ϕ}_{h} \qquad 6 - 3 )$$

φₕ is degenerate temperature (Uₕ^{T}T).

Further, applying discrete empirical interpolation method (DEIM) to the radiation term in equation (5) yields the following expression.

R¹T*⁴⇒Uₕ^{t}R^{I}wₕ((P¹)^{T}Wₕ)⁻¹((P¹)^{T}Uₕϕₕ)*⁴ (6-4)

In the equation, P is N×N_{q} matrix with each column being a fundamental unit vector.

Therefore, by applying (6-1) through (6-4) to each term in equation (5), the following degenerate heat transfer equation C1 is obtained.

$${C}_{r} \frac{d {ϕ}_{h}}{d t} + {K}_{r} {ϕ}_{h} = {\sum }_{I = 1}^{{N}_{H T C}} H T {C}^{I} ( {T}_{g}^{I} {E}_{1 r}^{I} - {M}_{r}^{I} {ϕ}_{h} ) + {\sum }_{I = 1}^{{N}_{R D}} {Q}^{I} {{\hat{R}}^{I} ( {\hat{P}}^{I} {ϕ}_{h} )}^{* 4} \qquad ( 7 )$$

$${C}_{r} = {U}_{h}^{T} {CU}_{h} \qquad ( 8 )$$

$${K}_{r} = {U}_{h}^{T} K {U}_{h} \qquad ( 9 )$$

$${E}_{r}^{I} = {U}_{h}^{T} {E}^{I} \qquad ( 10 )$$

$${M}_{r}^{I} = {U}_{h}^{T} {M}^{I} {U}_{h} \qquad ( 11 )$$

$${\hat{R}}^{I} = {U}_{h}^{t} {R}^{I} {{W}_{h} ( {( {P}^{I} )}^{T} {W}_{h} )}^{- 1} \qquad ( 12 )$$

$${\hat{P}}^{I} = {( {P}^{I} )}^{T} {U}_{h} \qquad ( 13 )$$

In the above equations, Cᵣ, Kᵣ, Eᵣ^{I}, Mᵣ^{I}, \hat{R}^{I}, and \hat{P}^{I} are calculated in advance because calculations take time.

As the deformation constitutive equation C2 included in the prediction model m, for example, the following equations using Norton's law can be used.

$$ϵ = {ϵ}^{e} + {ϵ}^{p} \qquad ( 14 - 1 )$$

$$\tilde{σ} = ( 1 - D ) σ \qquad ( 14 - 2 )$$

$${ϵ}^{e} = \frac{1 + v}{E} \tilde{σ} - \frac{v}{E} ( tr \tilde{σ} ) I \qquad ( 14 - 3 )$$

$$\frac{d {ϵ}^{p}}{d t} = \frac{3}{2} \frac{{\tilde{σ}}^{D} - {A}^{D}}{{( \tilde{σ} - A )}_{E Q}} \frac{d p}{dt} H ( f ) \qquad ( 14 - 4 )$$

$${( \tilde{σ} - A )}_{EQ} = {[ \frac{3}{2} ( {\tilde{σ}}^{D} - {A}^{D} ) : ( {\tilde{σ}}^{D} - {A}^{D} ) ]}^{1 / 2} \qquad ( 14 - 5 )$$

$$\frac{dp}{dt} = {〈 \frac{f}{K} 〉}^{N c} \qquad ( 14 - 6 )$$

$$f = {( \tilde{σ} - A )}_{E Q} - R - {σ}_{Y} \qquad ( 14 - 7 )$$

$$R = {R}_{∞} [ 1 - exp ( - b ( 1 - D ) \frac{d p}{dt} ) ] \qquad ( 14 - 8 )$$

$$\frac{dA}{d t} = \frac{2}{3} γ {A}_{∞} ( 1 - D ) \frac{d {ϵ}^{p}}{dt} - γ A ( 1 - D ) \frac{d p}{dt} \qquad ( 14 - 9 )$$

In the above equations, ∈ is strain tensor, ç^{e} is elastic strain tensor, ∈^{p} is visco-plasticity stain tensor, σ is stress tensor, \tilde{σ} is effective stress tensor, σ_{Y} is yield stress, v is Poisson's ratio, E is modulus of longitudinal elasticity, R is isotropic hardening variable, A is transfer hardening variable, b, γ, R∞, and A∞ are plasticity parameters (temperature-dependent material constants), K and Nc are Norton law parameters (temperature-dependent material constants), ( )^{D} is deviation component of tensor. D is obtained from D=Df+Dc, using Df (fatigue damage without creep effect) and Dc (creep damage without fatigue effect) obtained from the damage evolution equation C4.

Then, the force balance equation C3 included in the prediction model m is expressed by the following equation.

∫ᵥδç:σdV=∫_{V}δ∈:α(T−T₀)dV+∫_{V}δuρω²F₀dS−∫ₛ_{ₛ}δu pn dS (15)

In the equation, a is stress tensor, p is pressure, n is normal vector, p is density, w is angular velocity, F₀ is centrifugal force when ω=1 in the angular velocity unit system used, a is linear expansion coefficient tensor, T is temperature, T₀ is temperature at which thermal strain is 0, δu is virtual displacement, and δϵ is virtual strain tensor.

In the force balance equation C3, actually, the displacement is calculated from the above equation and the constraint conditions, but here, for simplicity of explanation, the constraint conditions are assumed to be implicitly taken into account.

Such a force balance equation C3 can be degenerated by the integration point reduction method, for example, as shown in FIG. 7E. By applying the finite element method to equations (14-1) to (14-9) and equation (15), stress a and displacement δu are obtained in multiple analysis cases, and the displacement u is used as virtual displacement δu to obtain virtual strain (step S300).

αₗ (i=1, . . . , N_{σ}) Training dataset for integration point stress tensor
δçₗ (i=1, . . . , N_{δ∈}_{ₗ}) Training dataset for integration point virtual strain tensor

Then, a set of finite element integration points pᵢ (i=1, . . . , N_{qp}) and the number of reduced integration points C are assumed and set to C=1 (step S301). From the set of integration points pᵢ, C integration points are selected and denoted as qⱼ, and the positive weight of qⱼ is defined as wⱼ (step S302). This results in the following approximation of the virtual work of internal forces.

∫_{V}δ∈:σdV≈Σⱼ₌₁^{C}δ∈(qⱼ):σᵢ(qⱼ)wⱼ (16)

Then, for all combinations of training data sets σᵢ and δεᵢ, “method of selecting C integration points” and “weight thereof” that give the best approximation accuracy in the above equation are determined (step S303). If the optimal solution obtained in step S303 has sufficient approximation accuracy, or if C reaches a predetermined natural number (step S304: YES), this solution is the final solution (step S305). Conversely, if neither condition is satisfied (step S304: NO), the number of integration points is incremented by one (C←C+1), and the process returns to step S302.

As a result, as shown in FIG. 7F, it is possible to obtain integration points that allow accurate numerical integration with a small number of points based on (multiple) precalculated results of stress or strain.

The force balance equation C3 shown in the above equation (15) is discretized by the finite element method and numerically integrated using integration points reduced only to virtual work due to internal forces, and is expressed by the following equation.

Πu=Θ(T−T₀)+ω²Λ−Σ_{I=1}^{N}^{_{PRES}}p^{l}T^{I} (17)

In equation (17), the left side is an internal force term, the first term on the right side is a heat load term, the second term on the right side is a centrifugal force term, and the third term on the right side is a pressure term. U is 0-dimensional nodal displacement vector, T is N-dimensional nodal temperature vector, T₀ is N-dimensional nodal temperature vector with zero thermal strain, w is angular velocity, p^{I} is pressure, H is M×M matrix, Θ is M×N matrix, Λ and Γ^{I} are M-dimensional vectors.

uᵢ (i=1, . . . ) is a set of nodal displacement vectors obtained by solving equation (17), and Uₛ is N×Nₛ matrix U when Ns-dimensional truncated SVD is applied to X=[u₁, u₂, . . . ]. In this case, POD Galerkin projections of each term of equation (17) are expressed by the following expressions.

Πu⇒(Uₛ^{T}ΠUₛ)ϕₛ (18-1)

Θ(T−T₀)⇒Uₛ^{T}ΘUₕ(ϕₕ−ϕ_{h,0}) (18-2)

ω²Λ⇒ω²Uₛ^{T}Λ (18-3)

p¹Γ¹⇒p¹Uₛ^{T}Γ^{l} (18-4)

φs is degenerate displacement (=Uₛ^{T}u), and φ_{h,0}=Uₕ^{T}T₀.

Therefore, by applying (18-1) through (18-4) to each term in equation (17), the following degenerate force balance equation C3 is obtained.

Πᵣϕₛ=Θᵣ(ϕₕ−ϕ_{h,0})+ω²Λᵣ−Σₗ₌₁^{N}^{_{PRES}}p^{l}Γᵣ^{l} (19)

Πᵣ=(Uₛ^{T}ΠUₛ) (20)

Θᵣ=U_{S}^{T}ΘUₕ (21)

Λᵣ=Uₛ^{T}Λ (22)

Γᵣ^{I}=Uₛ^{T}Γ^{l} (23)

In the above equations, Θᵣ, Kᵣ, Γᵣ^{I} are calculated in advance because calculations take time. Πᵣ and the deformation constitutive equation C2 in conjunction with Πᵣ can be obtained using only the reduced integration points, and the computational load is small. Therefore, Πᵣ and the deformation constitutive equation C2 can be calculated during real-time monitoring.

With the above-described reduced order model M, the values of degenerate temperature ϕₕ, degenerate displacement ϕₛ, and stress at the reduced integration points can be obtained. The temperature and displacement can be obtained by the following equations.

T=Uₕϕₕ

u=Uₛϕₛ

As for stress, the entire stress field can be obtained by restoring the stress values at the other integration points from the stress values at the reduced integration points by the Gappy POD, which is a method for restoring missing data.

In the rotating machinery evaluation device 100 according to the present embodiments, by calculating the evaluation value using the reduced order model M thus constructed from the prediction model m, the calculation load can be greatly reduced compared to the case where the prediction model m is used. As a result, it is possible to quickly calculate the evaluation value based on the measured values acquired during the operation of the rotating machinery 1 and monitor the rotating machinery 1 in real time.

As described above, the reduced order model M is constructed based on the prediction model m. In the rotating machinery evaluation device 100 according to some embodiments, the calculation accuracy of the evaluation value by the reduced order model M may be improved by tuning the base prediction model m. Tuning of the prediction model m is performed by adjusting a parameter included in the heat transfer model m1 of the prediction model m.

The rotating machinery evaluation device 100 shown in FIG. 2 includes a parameter adjustment unit 114 for performing the tuning of the prediction model m. In this embodiment, the parameter adjustment unit 114 is provided as a part of the configuration of the rotating machinery evaluation device 100, and the predictive model m is tuned by the parameter adjustment unit 114 at a predetermined timing to improve the accuracy of the reduced order model M stored in the storage unit 106. In another embodiment, the rotating machinery evaluation device 100 may not include such a parameter adjustment unit 114, and for example, the operator may tune the prediction model m to update the reduced order model M constructed based on the prediction model m, thereby improving the evaluation accuracy.

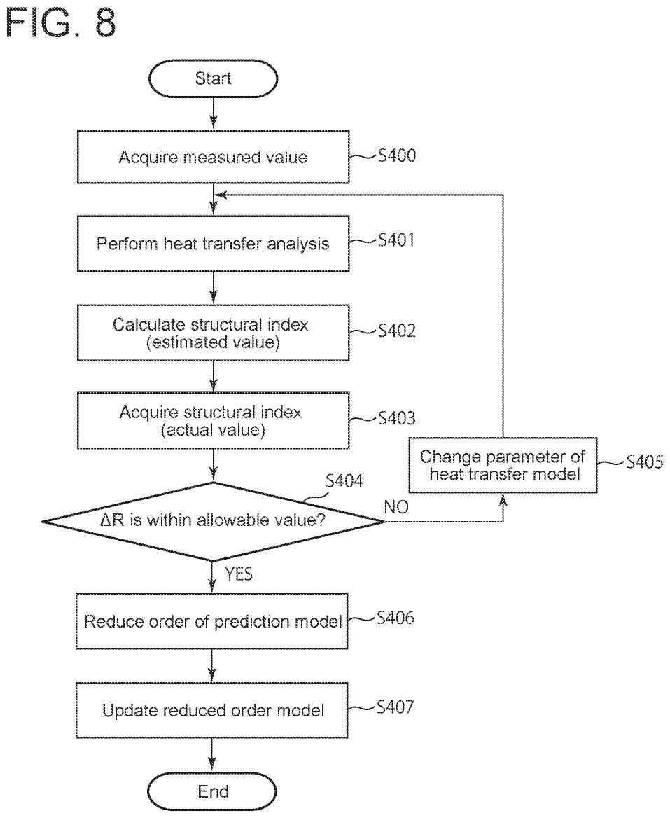

FIG. 8 is a flowchart of the tuning method for the rotating machinery evaluation device 100 according to an embodiment.

First, the parameter adjustment unit 114 acquires a measured value related to the operating state of the rotating machinery 1 (step S400). Acquisition of the measured value in step S400 is the same as acquisition of the measured value by the measured value acquisition unit 102 described above. Then, the parameter adjustment unit 114 performs heat transfer analysis by applying the measured value acquired in step S400 to the heat transfer model m1 of the prediction model m to be tuned (step S401), and calculates a structural index (estimated value) (step S402). In this embodiment, elongation of the rotor 4 is used as the structural index, but other parameters may be used.

Then, the parameter adjustment unit 114 acquires an actual value of the structural index calculated in step S402 (step S403). The actual value of the structural index may be obtained together with other parameters in step S400. In this embodiment, the actual value of elongation of the rotor 4 calculated in step S402 is obtained.

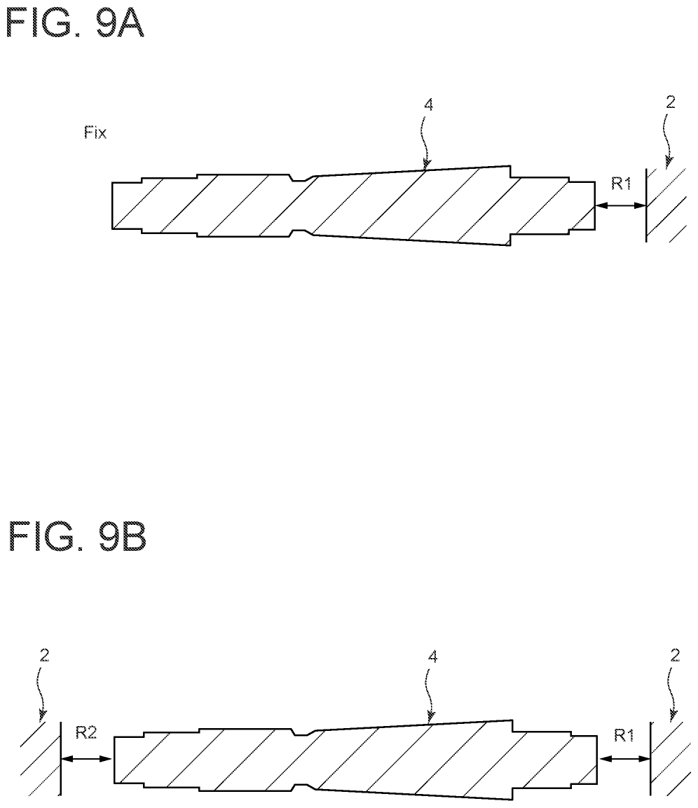

FIGS. 9A and 9B are each a schematic diagram showing elongation of the rotor 4 calculated as the structural index in step S402 of FIG. 8. In FIG. 9A, one end of the rotor 4 is fixed to the casing 2, and the elongation at the other end is used as the structural index. In this case, the actual value R (=R1−r1) of the elongation of the rotor 4 can be obtained by measuring the relative distance R1 to the other end of the rotor 4 by an optical sensor installed on the inner surface of the casing 2, and subtracting the elongation r1 of the casing 2 measured by another sensor from the relative distance R1.

In FIG. 9B, when both ends of the rotor 4 are not fixed, the actual value R (=(R1−r1)±(R2−r2)) of the elongation of the rotor 4 can be obtained by measuring the relative distances R1, R2 to each end of the rotor 4 by an optical sensor installed on the inner surface of the casing 2, and measuring the elongations r1, r2 of the casing 2 measured by another sensor.

Then, the parameter adjustment unit 114 determines whether a difference ΔR between the elongation (estimated value) calculated in step S402 and the actual elongation acquired in step S403 is within an allowable value (step S404). If the difference ΔR exceeds the allowable value (step S404: NO), the parameter adjustment unit 114 changes a parameter included in the heat transfer model m1 (step S405). The parameter change in step S405 can be automated using, for example, an optimization algorithm.

Some examples of parameter change patterns in step S405 will now be described. As a first example, a parameter related to the steam temperature condition included in the heat transfer model m1 may be changed. The steam temperature condition can be tuned, for example, based on a measured value of the steam temperature. Examples of the effective steam temperature measurement point include: (i) the steam inlet portion 2a for the blade ring 10 and the dummy ring 14, or if the rotor 4 has a weld, the vicinity of the weld; (ii) the tips of the stator vanes constituting the stator vane row 12 between the blade ring 10 and the rotor 4; and (iii) the inner gland 15.

As a second example, a parameter related to the heat transfer coefficient included in the heat transfer model m1 may be changed. The heat transfer coefficient in the rotating machinery 1 is closely related to the operating state of the rotating machinery 1. For example, when the rotating machinery 1 is in operation, the heat transfer coefficient α is expressed by the following equation.

$$α = {a}_{1} {{α}_{rate} ( \frac{P}{{P}_{rate}} )}^{n} \qquad ( 24 - 1 )$$

In the equation, αᵣₐₜₑ is heat transfer coefficient evaluation value at rating, Pᵣₐₜₑ is pressure evaluation value at rating, P is pressure evaluation value, and n is index.

Further, when the rotating machinery 1 is in a stopped state (the pressure in the internal passage 14 is close to vacuum), the heat transfer coefficient α is expressed by the following equation.

α=α₂α_{vacuum} (24-2)

In the equation, α_{vacuum} is heat transfer coefficient evaluation value in vacuum. Further, when the rotating machinery 1 is in a stopped state (air flows into the internal passage 14 and breaks vacuum), the heat transfer coefficient α is expressed by the following equation.

α=α₃αₐᵢᵣ (24-3)

In the equation, αₐᵢᵣ is heat transfer coefficient evaluation value in vacuum break. In this case, the parameter adjustment unit 114 can adjust parameters α1 to α3 included in equations (24-1) to (24-3).

As a third example, a parameter related to radiant heat Q′ included in the heat transfer model m1 may be changed. Hypothetically, the radiant heat Q′ given from the area A1 of the high-temperature rotor 4 to the area A2 of the low-temperature blade ring 10 is expressed by the above equation (4) using the emissivity e1 of the blade ring 10, the emissivity e2 of the rotor 4, and the Stefan-Boltzmann constant σ.

Then, the process returns to step S401, and the heat transfer analysis is performed again using the heat transfer model m1 with the changed parameter. Such process is repeated until the difference ΔR falls below the allowable value. That is, the parameter included in the heat transfer model m1 is adjusted so that the predicted value of the structural index coincides with the actual value of the structural index.

If the difference ΔR is within the allowable value (step S404: YES), the predictive FEM model m including the heat transfer model m1 with the parameter changed in step S405 is reduced again (step S406), and the reduced order model M stored in the storage unit 106 is updated (step S407).

By tuning the prediction model m in this way to update the reduced order model M, the evaluation accuracy using the reduced order model M can be improved.

In the present embodiments, the rotating machinery evaluation device 100 has been described, but the present invention is not limited to such a configuration, and a client terminal device (not shown) capable of communicating with the rotating machinery evaluation device 100 may be configured to output the evaluation result in step S104.

Further, in response to request from the client terminal device to evaluate the rotating machinery, the process of the flowchart showing the rotating machinery evaluation method shown in FIG. 3 or the tuning method shown in FIG. 8 may be executed.

Further, the operator may input an instruction for tuning the prediction model m to the client terminal device.

In addition, the components in the above-described embodiments may be appropriately replaced with known components without departing from the spirit of the present disclosure, or the above-described embodiments may be appropriately combined.

The contents described in the above embodiments would be understood as follows, for instance.

(1) A rotating machinery evaluation device (e.g., the rotating machinery evaluation device 100 according to the above-described embodiments) according to an aspect includes: a boundary condition calculation unit (e.g., the boundary condition calculation unit 104 according to the above-described embodiments) for calculating a boundary condition based on a measured value of a parameter related to an operating state of rotating machinery (e.g., the rotating machinery 1 according to the above-described embodiments); a storage unit (e.g., the storage unit 106 according to the above-described embodiments) for storing a reduced order model (e.g., the reduced order model M according to the above-described embodiments) created based on a prediction model (e.g., the prediction model m according to the above-described embodiments) constructed so as to include a heat transfer model (e.g., the heat transfer model m1 according to the above-described embodiments) and a structural model (e.g., the structural model m2 according to the above-described embodiments) of the rotating machinery for predicting an evaluation value of the rotating machinery corresponding to the boundary condition; and an evaluation value calculation unit (e.g., the evaluation value calculation unit 108 according to the above-described embodiments) for calculating the evaluation value corresponding to the boundary condition calculated by the boundary condition calculation unit, based on the reduced order model, during operation of the rotating machinery.

According to the above aspect (1), the evaluation value corresponding to the boundary condition calculated from the measured value of the parameter related to the operating state of the rotating machinery is calculated based on the reduced order model. The reduced order model, which is created by reducing the order of the prediction model, can significantly reduce the computational load. Therefore, the evaluation value can be calculated accurately and quickly during operation of the rotating machinery. This allows the operator to monitor the evaluation value in real time during operation of the rotating machinery.

(2) In another aspect, in the above aspect (1), the reduced order model is created by reducing integration points in an integral equation included in the prediction model.

According to the above aspect (2), by applying the integration point reduction method to the prediction model, it is possible to calculate the evaluation value with good accuracy and to suitably create the reduced order model with a small computational load.

(3) In another aspect, in the above aspect (1) or (2), the prediction model includes a heat transfer equation (e.g., the heat transfer equation C1 according to the above-described embodiment), a deformation constitutive equation (e.g., the deformation constitutive equation C2 according to the above-described embodiment), a force balance equation (e.g., the force balance equation C3 according to the above-described embodiment), and a damage evolution equation (e.g., the damage evolution equation C4 according to the above-described embodiment). The reduced order model is created by POD Galerkin projection of at least one term included in the heat transfer equation or the force balance equation of the prediction model.

According to the above aspect (3), by applying the POD Galerkin projection to at least part of the heat transfer equation or the force balance equation of the prediction model, it is possible to calculate the evaluation value with good accuracy and to suitably create the reduced order model with a small computational load.

(4) In another aspect, in any one of the above aspects (1) to (3), the evaluation value includes stress occurring in the rotating machinery or damage to the rotating machinery calculated based on the stress.

According to the above aspect (4), by obtaining stress or damage as the evaluation value, it is possible to accurately obtain information necessary for diagnosing the remaining life of the rotating machinery.

(5) In another aspect, in any one of the above aspects (1) to (4), the rotating machinery evaluation device further includes a parameter adjustment unit (e.g., the parameter adjustment unit 114 according to the above-described embodiment) for adjusting a parameter included in the heat transfer model so that a predicted value of a structural index of the rotating machinery calculated by applying the measured value of the parameter to the heat transfer model coincides with an actual value of the structural index.

According to the above aspect (5), the parameter included in the heat transfer model is adjusted (tuned) so that the predicted value of the structural index obtained from the parameter coincides with the actual value. This improves the accuracy of the heat transfer model. As a result, it is possible to effectively improve the calculation accuracy of the evaluation value by the reduced order model constructed from the prediction model including the heat transfer model.

(6) In another aspect, in the above aspect (5), the structural index is an elongation amount along an axial direction of a rotating member (e.g., the rotor 4 according to the above-described embodiment) of the rotating machinery.

According to the above aspect (6), by adopting the elongation amount along the axial direction of a rotating member (e.g., turbine rotor) of the rotating machinery as the structural index used in tuning, the parameter can be adjusted appropriately.

(7) In another aspect, in the above aspect (5) or (6), the parameter adjustment unit is configured to adjust a parameter related to a heat transfer coefficient selected according to an operating mode of the rotating machinery.

According to the above aspect (7), by selecting the parameter to be adjusted according to the operating mode, it is possible to construct the reduced order model capable of more accurately calculating the evaluation value regarding the operating state of the rotating machinery.

(8) A rotating machinery evaluation device tuning method according to an aspect is a method for tuning the rotating machinery evaluation device according to any one of the above (1) to (4), including adjusting a parameter included in the heat transfer model so that a predicted value of a structural index of the rotating machinery calculated by applying the measured value of the parameter to the heat transfer model coincides with an actual value of the structural index.

According to the above aspect (8), the parameter included in the heat transfer model is adjusted (tuned) so that the predicted value of the structural index obtained from the parameter coincides with the actual value. This improves the accuracy of the heat transfer model. As a result, it is possible to effectively improve the calculation accuracy of the evaluation value by the reduced order model constructed from the prediction model including the heat transfer model.

(9) In another aspect, in the above aspect (8), the structural index is an elongation amount along an axial direction of a rotating member (e.g., the rotor 4 according to the above-described embodiment) of the rotating machinery.

According to the above aspect (9), by adopting the elongation amount along the axial direction of a rotating member (e.g., turbine rotor) of the rotating machinery as the structural index used in tuning, the parameter can be adjusted appropriately.

(10) In another aspect, in the above aspect (8) or (9), the method includes adjusting a parameter related to a heat transfer coefficient selected according to an operating mode of the rotating machinery.

According to the above aspect (10), by selecting the parameter to be adjusted according to the operating mode, it is possible to construct the reduced order model capable of more accurately calculating the evaluation value regarding the operating state of the rotating machinery.

(11) A rotating machinery evaluation method according an aspect includes: a step of calculating a boundary condition based on a measured value of a parameter related to an operating state of rotating machinery (e.g., the rotating machinery 1 according to the above-described embodiments); and a step of calculating an evaluation value corresponding to the calculated boundary condition, based on a reduced order model (e.g., the reduced order model M according to the above-described embodiments), during operation of the rotating machinery. The reduced order model is created based on a prediction model (e.g., the prediction model m according to the above-described embodiments) constructed so as to include a heat transfer model (e.g., the heat transfer model m1 according to the above-described embodiments) and a structural model (e.g., the structural model m2 according to the above-described embodiments) of the rotating machinery for predicting an evaluation value of the rotating machinery corresponding to the boundary condition.

According to the above aspect (11), the evaluation value corresponding to the boundary condition calculated from the measured value of the parameter related to the operating state of the rotating machinery is calculated based on the reduced order model. The reduced order model, which is created by reducing the order of the prediction model, can significantly reduce the computational load. Therefore, the evaluation value can be calculated accurately and quickly during operation of the rotating machinery. This allows the operator to monitor the evaluation value in real time during operation of the rotating machinery.

(12) A rotating machinery evaluation system according to an aspect includes: a client terminal device; and a rotating machinery evaluation device capable of communicating with the client terminal device. The client terminal device includes a request means for requesting evaluation of rotating machinery to the rotating machinery evaluation device. The rotating machinery evaluation device includes: a boundary condition calculation unit (e.g., the boundary condition calculation unit 104 according to the above-described embodiments) for calculating a boundary condition based on a measured value of a parameter related to an operating state of rotating machinery in response to request from the request means; a storage unit (e.g., the storage unit 106 according to the above-described embodiments) for storing a reduced order model (e.g., the reduced order model M according to the above-described embodiments) created based on a prediction model (e.g., the prediction model m according to the above-described embodiments) constructed so as to include a heat transfer model (e.g., the heat transfer model m1 according to the above-described embodiments) and a structural model (e.g., the structural model m2 according to the above-described embodiments) of the rotating machinery for predicting an evaluation value of the rotating machinery corresponding to the boundary condition; and an evaluation value calculation unit (e.g., the evaluation value calculation unit 108 according to the above-described embodiments) for calculating the evaluation value corresponding to the boundary condition calculated by the boundary condition calculation unit, based on the reduced order model, during operation of the rotating machinery.

According to the above aspect (12), the rotating machinery evaluation system includes the client terminal device and the rotating machinery evaluation device that can communicate with each other. As a result, even when the client terminal device and the rotating machinery evaluation device are arranged at positions apart from each other, the rotating machinery evaluation device can evaluate the rotating machinery in response to request from the request means of the client terminal device.

### REFERENCE SIGNS LIST

1 Rotating machinery
2 Casing
2a Steam inlet portion
4 Rotor
6 Radial bearing
8 Rotor blade row
10 Blade ring
12 Stator vane row
13 Dummy ring
14 Internal passage
15 Inner gland
100 Rotating machinery evaluation device
102 Measured value acquisition unit
104 Boundary condition calculation unit
106 Storage unit
108 Evaluation value calculation unit
110 Result output unit
Dc Creep damage
Df Fatigue damage
M Reduced order model
m Prediction model
m1 Heat transfer model
m2 Structural model

1. A rotating machinery evaluation device, comprising:
a boundary condition calculation unit for calculating a boundary condition based on a measured value of a parameter related to an operating state of rotating machinery;
a storage unit for storing a reduced order model created based on a prediction model constructed so as to include a heat transfer model and a structural model of the rotating machinery for predicting an evaluation value of the rotating machinery corresponding to the boundary condition; and
an evaluation value calculation unit for calculating the evaluation value corresponding to the boundary condition calculated by the boundary condition calculation unit, based on the reduced order model, during operation of the rotating machinery.

2. The rotating machinery evaluation device according to claim 1,
wherein the reduced order model is created by reducing integration points in an integral equation included in the prediction model.

3. The rotating machinery evaluation device according to claim 1,
wherein the prediction model includes a heat transfer equation, a deformation constitutive equation, a force balance equation, and a damage evolution equation, and
wherein the reduced order model is created by POD Galerkin projection of at least one term included in the heat transfer equation or the force balance equation of the prediction model.

4. The rotating machinery evaluation device according to claim 1,
wherein the evaluation value includes stress occurring in the rotating machinery or damage to the rotating machinery calculated based on the stress.

5. The rotating machinery evaluation device according to claim 1, further comprising a parameter adjustment unit for adjusting a parameter included in the heat transfer model so that a predicted value of a structural index of the rotating machinery calculated by applying the measured value of the parameter to the heat transfer model coincides with an actual value of the structural index.

6. The rotating machinery evaluation device according to claim 5,
wherein the structural index is an elongation amount along an axial direction of a rotating member of the rotating machinery.

7. The rotating machinery evaluation device according to claim 5,
wherein the parameter adjustment unit is configured to adjust a parameter related to a heat transfer coefficient selected according to an operating mode of the rotating machinery.

8. A rotating machinery evaluation device tuning method for tuning the rotating machinery evaluation device according to claim 1, comprising
adjusting a parameter included in the heat transfer model so that a predicted value of a structural index of the rotating machinery calculated by applying the measured value of the parameter to the heat transfer model coincides with an actual value of the structural index.

9. The rotating machinery evaluation device tuning method according to claim 8,
wherein the structural index is an elongation amount along an axial direction of a rotating member of the rotating machinery.

10. The rotating machinery evaluation device tuning method according to claim 8, comprising
adjusting a parameter related to a heat transfer coefficient selected according to an operating mode of the rotating machinery.

11. A rotating machinery evaluation method, comprising:
a step of calculating a boundary condition based on a measured value of a parameter related to an operating state of rotating machinery; and
a step of calculating an evaluation value corresponding to the calculated boundary condition, based on a reduced order model, during operation of the rotating machinery,
wherein the reduced order model is created based on a prediction model constructed so as to include a heat transfer model and a structural model of the rotating machinery for predicting an evaluation value of the rotating machinery corresponding to the boundary condition.

12. A rotating machinery evaluation system, comprising:
a client terminal device; and
a rotating machinery evaluation device capable of communicating with the client terminal device,
wherein the client terminal device includes
a request means for requesting evaluation of rotating machinery to the rotating machinery evaluation device, and
wherein the rotating machinery evaluation device includes:
a boundary condition calculation unit for calculating a boundary condition based on a measured value of a parameter related to an operating state of the rotating machinery in response to request from the request means;
a storage unit for storing a reduced order model created based on a prediction model constructed so as to include a heat transfer model and a structural model of the rotating machinery for predicting an evaluation value of the rotating machinery corresponding to the boundary condition; and
an evaluation value calculation unit for calculating the evaluation value corresponding to the boundary condition calculated by the boundary condition calculation unit, based on the reduced order model, during operation of the rotating machinery.
